(19) United States
(12) Patent Application Publication
(10) Pub. No.: US 2018/0304270 A1
(43) Pub. Date: Oct. 25, 2018

(54) ECCENTRIC CRUSHING JAW MOUNTING ASSEMBLY

(71) Applicant: SANDVIK INTELLECTUAL PROPERTY AB, Sandviken (SE)

(72) Inventors: Johan SVENSSON, Malmo (SE); Arvid SVENSSON, Bunkeflostrand (SE); Per SVEDENSTEN, Svedala (SE)

(21) Appl. No.: 15/738,070

(22) PCT Filed: Jun. 25, 2015
(86) PCT No.: PCT/EP2015/064380

§ 371 Date: Dec. 19, 2017

(51) Int. Cl. B02C 1/04; B02C 1/10

(52) U.S. Cl. CPC B02C 1/04; B02C 1/10

(57) ABSTRACT

A mounting assembly arranged to mount a jaw at a jaw crusher includes a rotatable shaft having a jaw bearing mount region that is eccentric relative to a longitudinal axis of the shaft. A central axis of a jaw bearing that mounts the jaw at the crusher is off-set from a central axis of a frame bearing that mounts the shaft at the crusher by a distance in the range of 20 mm to 35 mm.

### FIELD OF INVENTION

The present invention relates to a crushing jaw mounting assembly for mounting a movable jaw at a jaw crusher having an optimised eccentric throw for maximising crusher capacity.

### BACKGROUND ART

Jaw crushers typically comprise a fixed jaw and a movable jaw that together define a crushing zone. A drive mechanism is operative to rock the movable jaw back and forth in order to crush material within this zone. The crushing zone is generally convergent towards its lower discharge end so that crushable material, fed to an upper and wider end of the zone, is capable of falling downward under gravity whilst being subject to repeated cycles of crushing movement in response to the cyclical motion of the movable jaw. The crushed material is then discharged under gravity through the lower and narrower discharge end onto a conveyor for onward processing or a stockpiling.

Example jaw crushers in which a movable jaw oscillates back and forth relative to a stationary jaw are described in GB 569,705; U.S. Pat. No. 2,380,419; U.S. Pat. No. 2,532,678; U.S. Pat. No. 2,738,933; U.S. Pat. No. 3,894,698 and U.S. Pat. No. 6,641,068. Typically, the movable jaw is mounted eccentrically via a rotatable shaft to achieve and determine a throw or stroke of the crusher. The extent of the eccentricity affects the displacement of the moving jaw and, in part, the characteristics and dynamics of the crusher. Moreover, the capacity of the crusher is dependent on the horizontal distance between the opposed crushing plates mounted on each jaw, the ‘nip angle’ in the crushing zone and the rotational speed of the rotatable shaft. Adjustments of these physical and operating parameters receive constant attention in order to optimise or maximise the throughput capacity (defined in tons per hour) without necessitating unacceptable power-draw (typically considered in terms of horsepower). Attempts have been made to adjust the toggle plate angle to optimise capacity. However, a steeper angle whilst improving capacity (and throw at the lower region of the jaw) is limited by operating forces.

U.S. Pat. No. 5,110,057 describes a method of operating a crusher by increasing the throw of the movable jaw in an attempt to increase capacity without increasing the crushing force. However, there exist a need for a jaw crusher and in particular a mounting assembly for a movable jaw that better optimises capacity without compromising other physical and operational characteristics of the crusher.

### SUMMARY OF THE INVENTION

It is an objective of the present invention to provide an assembly for mounting a movable jaw of a jaw crusher that is configured to provide a desired throw or stroke of the jaw as it oscillates relative to a stationary jaw in order to maximise capacity whilst achieving a desired reduction. It is a further objective to optimise the capacity of the crusher without compromising other physical and/or operational characteristics and in particular without increasing appreciably the overall weight of the crusher.

In particular, it is a specific objective to provide a jaw crusher offering a maximised capacity and desired reduction with respect to the rate by which material falls through the crushing zone under gravity and is compressed between the jaw plates as the moveable jaw oscillates relative to the fixed jaw.

The objectives are achieved by a mounting arrangement of the jaw within the crusher that comprises a mounting shaft with eccentric regions on which the jaw is mounted to achieve a desired magnitude of throw or stroke during crushing operation. In particular, the mounting arrangement is configured to suspend the movable jaw at its uppermost end via a pair of jaw bearings that provide an intermediate coupling between the jaw and the shaft. An enhanced and optimised stroke is achieved as the jaw bearings are mounted eccentrically relative to corresponding frame bearings (that mount the shaft at a frame of the crusher). The inventors have identified that an off-set alignment distance (in the radial direction) of a central axis of the jaw bearing relative to a central axis of the frame bearing of between 20 mm to 35 mm provides the desired throw and displacement of the movable jaw at all regions along the jaw length from an uppermost to a lowermost region. Such a configuration provides that the entire volume of the crushing zone between the uppermost and lowermost jaws ends is optimised including the crushing action at the lower region (discharge end) that is also influenced by other factors such as the toggle plate angle for example.

According to a first aspect of the present invention there is provided a crushing jaw mounting assembly for a jaw crusher comprising: a rotatable shaft to mount a first crushing jaw and by rotation cause the jaw to oscillate relative to a second jaw of a crusher, the shaft having at least one jaw bearing mount region that is eccentric relative to a central longitudinal axis of the shaft; at least one jaw bearing mounted in contact around the mount region of the shaft, the jaw bearing configured to provide an intermediate mount of the first jaw at the shaft; at least one frame bearing mounted in contact around the shaft axially to one side of the jaw bearing to rotatably mount the shaft at a frame of the jaw crusher; characterised in that: a central axis of the eccentrically mounted jaw bearing is off-set from a central axis of the frame bearing by a distance in the range 20 mm to 35 mm. Optionally, the eccentric distance may be in the range 20 mm to 34 mm, 20 mm to 32 mm, 20 mm to 30 mm, 20 mm to 28 mm, 20 mm to 26 mm, 20 mm to 24 mm. Optionally, the eccentric distance may be in the range 22 mm to 35 mm, 22 mm to 34 mm, 22 mm to 32 mm, 22 mm to 30 mm, 22 mm to 28 mm, 22 mm to 26 mm, 22 mm to 24 mm. Optionally, the eccentric distance may be in the range 24 mm to 35 mm, 24 mm to 34 mm, 24 mm to 32 mm, 24 mm to 30 mm, 24 mm to 28 mm, 24 mm to 26 mm. Optionally, the eccentric distance may be in the range 26 mm to 35 mm, 26 mm to 34 mm, 26 mm to 32 mm, 26 mm to 30 mm, 26 mm to 28 mm. Optionally, the eccentric distance may be in the range 20 to 28 mm, 22 to 32 mm, 20 to 26 mm or 24 to 35 mm. Such configurations are effective to provide the desired stroke and to maximise capacity. Additionally, such arrangements permit a lower operational crusher speed that is further advantageous to reduce noise emission whilst avoiding the creation of damaging forces.

The subject invention may be utilised with a variety of different crusher sizes with the selection of the magnitude of the throw being proportional to the crusher intake size in particular.

Preferably, the central axis of the jaw bearing is eccentrically mounted relative to a central axis of the shaft. Preferably, each of the jaw and frame bearings comprises an annular configuration. Such an arrangement provides a stable mounting of the rotatable shaft within the crusher to be compatible with existing flywheel and drive mechanisms. Additionally, to further stabilise the gyroscopic procession of the movable jaw, an inner diameter of the jaw bearing is greater than an inner diameter of the frame bearing. In particular, the difference in diameter of the jaw to frame bearings is at least twice the distance of the axis off-set distance such that the difference in the respective bearing diameters is in the range 40 to 80 mm, 40 to 70 mm, 40 to 60 mm, 50 to 80 mm, 50 to 70 mm, 50 to 60 mm.

Optionally, the crusher may further comprise at least one annular seat positioned radially intermediate the shaft and each of the jaw and/or frame bearings. A seat or gasket positioned radially between the bearing and the shaft may be utilised to accommodate or allow interchange of different sized bearings as required. The intermediate seat may also stabilise the bearings and help to reduce the transmission of vibrational forces within the jaw mounting assembly.

Preferably, the mount region for the jaw bearing is formed integrally with the shaft. A single-piece shaft is beneficial to optimise the strength of the assembly and minimise the creation of stress concentrations and fatigue at the shaft and/or bearings. Preferably, the junction or interface between the bearing mount region and the remainder of the shaft increases or decreases gradually via a tapered or curved region. That is, the eccentric mass at the jaw bearing mount region is configured as a gradual extension of the shaft in a radially outward direction. Again, such an arrangement is beneficial to reduce stress concentration at the shaft. Preferably, a radially outer surface of the shaft at the mount region is separated radially from the outer surface of the shaft that mounts the frame bearing by a distance in the range 20 mm to 35 mm.

Preferably, the assembly comprises two respective jaw and frame bearings, each of the frame bearings positioned axially outside the jaw bearings being axially closer to each respective end of the shaft. A dual set of each of the jaw and frame bearings represents an optimised compromise between stabilising the eccentric mounting of the jaw at the shaft (and the shaft at the crusher frame) whilst minimising the contribution to the overall weight of the crusher. The central axes may be considered to be centred relative to the radially external surfaces of the respective jaw bearing and frame bearing mount regions.

According to a second aspect of the present invention there is provided a jaw crusher comprising: a substantially stationary jaw; and a movable jaw movably mounted relative to the stationary jaw via the mounting assembly or shaft as claimed herein.

Optionally, a separation distance between uppermost edges of the first and second jaws is in a range of 600 to 1000 mm; a width of the first and second jaws in a direction perpendicular to the separation distance is in a range 800 to 1200 mm; and the jaw bearing off-set distance is in a range 20 to 28 mm. Optionally, a separation distance between upper most edges of the first and second jaws is in a range of 800 to 1200 mm; a width of the first and second jaws in a direction perpendicular to the separation distance is in a range 1000 to 1400 mm; and the jaw bearing off-set distance is in a range 20 to 30 mm. Optionally, a separation distance between upper most edges of the first and second jaws is in a range of 1200 to 1600 mm; a width of the first and second jaws in a direction perpendicular to the separation distance is in a range 1400 to 2200 mm; and the jaw bearing off-set distance is in a range 22 to 35 mm. Optionally, the jaw crusher according to specific implementations may comprise a feed opening (diameter×width) of (600 mm-1000 mm)×(800 mm-1200 mm); an angular velocity of the movement of jaw in the range 180 rpm-260 rpm; a motor with a power output in the range 110 kW-250 kW; and a bearing off-set distance in the range 20 mm-28 mm. Optionally, the jaw crusher according to specific implementations may comprise a feed opening (diameter×width) of (1000 mm-1300 mm)×(1200 mm-1500 mm); an angular velocity of the movement of jaw in the range 150 rpm-210 rpm; a motor with a power output in the range 200 kW-400 kW; and a bearing off-set distance in the range 22 mm-32 mm. Optionally, the jaw crusher according to specific implementations may comprise a feed opening (diameter×width) of (1300 mm-1700 mm)×(1500 mm-2200 mm); an angular velocity of the movement of jaw in the range 140 rpm-180 rpm; a motor with a power output in the range 300 kW-800 kW; and a bearing off-set distance in the range 24 mm-35 mm.

Optionally, the crusher may comprise a motor to actuate the oscillation of the movable jaw wherein the motor comprises an output power in the range 110 to 350 kW. Such a configuration is advantageous for an off-set distance in the range 20 to 24 mm and 24 to 28 mm. Optionally, the crusher may comprise a motor to actuate the oscillation of the movable jaw wherein the motor comprises an output power in the range 160 to 800 kW. Such a configuration may be optimised for a bearing off-set distance in the range 24 to 28 mm and 28 to 35 mm.

According to a third aspect of the present invention there is provided a method of operating a jaw crusher comprising: mounting a rotatable shaft within a frame of a jaw crusher via at least one frame bearing, the shaft having at least one jaw bearing mount region that is eccentric relative to a central longitudinal axis of the shaft; mounting a first crushing jaw at the mount region via at least one jaw bearing; characterised by: oscillating the first jaw by rotation of the shaft wherein a central axis of the eccentrically mounted jaw bearing is off-set from a central axis of the frame bearing by a distance in a range 20 to 35 mm.

The method of operating the jaw crusher utilising an eccentric distance 20 to 35 mm is compatible with movable jaw angular velocities that are lower than conventional crushers having the same respective intake size. In particular, the angular velocity of the movable jaw during operation may be in the range 140 to 260 or optionally 160 to 240 rpm for the eccentric distance 20 to 35 mm.

According to a fourth aspect of the present invention there is provided a mount shaft forming part of a crushing jaw mounting assembly for a jaw crusher comprising: a rotatable shaft to mount a first crushing jaw and by rotation cause the jaw to oscillate relative to a second jaw of a crusher, the shaft having at least one jaw bearing mount region that is eccentric relative to a central longitudinal axis of the shaft; characterised in that: a central axis of the jaw bearing mount region is off-set by a distance in the range 20 mm to 35 mm from the central longitudinal axis of the shaft.

### BRIEF DESCRIPTION OF DRAWINGS

A specific implementation of the present invention will now be described, by way of example only, and with reference to the accompanying drawings in which:

FIG. 1 is an external perspective view of a jaw crusher in which a sidewall is removed for illustrative purposes according to a specific implementation of the present invention;

FIG. 2 is a part cross sectional view through the mounting assembly that mounts the movable jaw within the crusher having an eccentric shaft and respective sets of bearing mountings according to the specific implementation of the present invention;

FIG. 3 is a further cross section through the bearing and shaft mounting assembly of FIG. 2;

FIG. 4 is an external side elevation view of the crusher of FIG. 1 also including the motor and drive transmission;

FIG. 5 is a plan view of the crusher of FIG. 4.

### DETAILED DESCRIPTION OF PREFERRED EMBODIMENT OF THE INVENTION

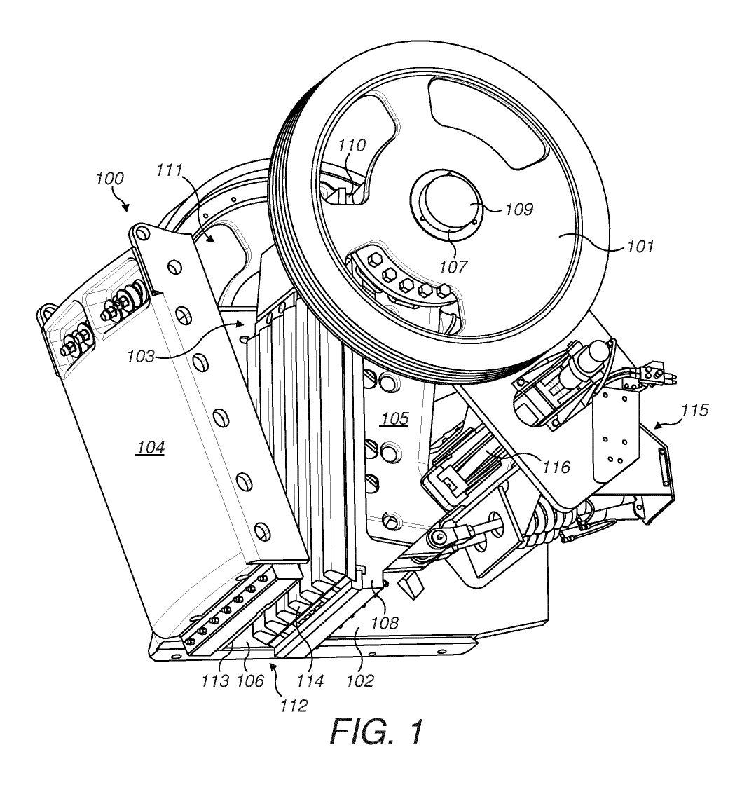

Referring to FIG. 1, a jaw crusher 100 comprises a main frame 102 upon which is mounted a movable jaw 105 and a substantially fixed jaw 104. Movable jaw 105 is mounted eccentrically at a rotatable shaft 107 (covered at its respective ends by a pair of end caps 109) and is positioned separated and opposed to fixed jaw 104. The orientation of fixed jaw 104 and movable jaw 105 relative to one another is convergent along their respective lengths such that a separation distance between fixed jaw 104 and movable jaw 105 decreases in the downward lengthwise direction. A crushing plate 113 is removably attached to fixed jaw 104 and a corresponding crushing plate 114 is removably attached to movable jaw 105 with the region between the opposed plates 113, 114 representing a crushing zone 103. Main frame 102 comprises two opposed frame walls that support the front frame end and extend either side of fixed jaw 104 and movable jaw 105 to further define the crushing zone 103. The opposed fixed 104 and movable 105 jaws are oriented to be inclined relative to one another and are spaced apart further at their respective upper ends 110 than their lower ends 108. Accordingly, the crushing zone 103 is convergent from an upper feed region 111 to a lower discharge region 112.

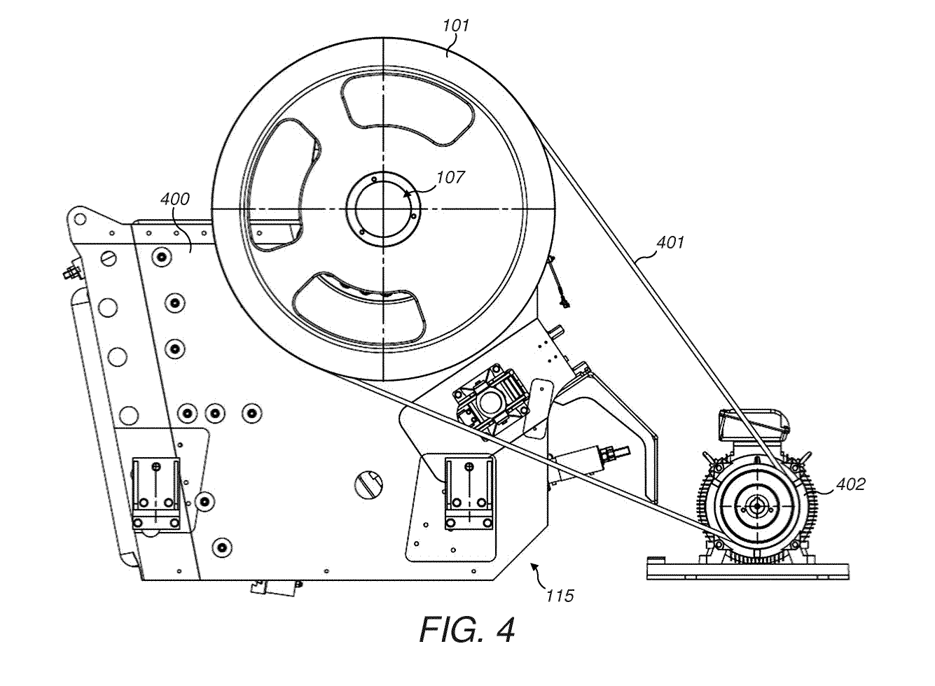

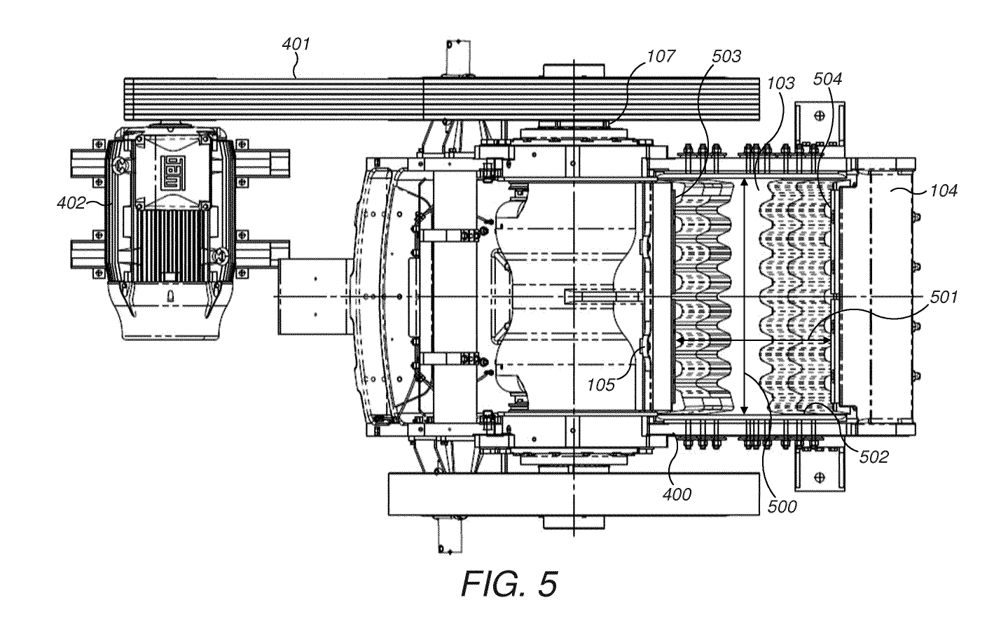

A pair of flywheels 101 are mounted at each end of shaft 107 at an external facing side of frame side walls being external to the crushing zone 103. Referring to FIGS. 4 and 5 crusher 100 further comprises a motor 402 drivably coupled to one of the flywheels 101 via a series of v-belts 401.

Movable jaw 105 is configured for gyroscopic or eccentric motion with respect of fixed jaw 104 as flywheels 101 and shaft 107 are rotated by motor 402. This movement of jaw 105 provides the necessary crushing action for material within zone 103 between the opposed plates 113 and 114. A plurality of removably mounted side liners 106 are attached to a respective sidewall 400 positioned at each widthwise end of crushing zone 103. Movable jaw 105 is supported by a back frame end 115 and in particular a mechanically actuated linkage having a toggle plate 116. Plate 116 is coupled to jaw lower end 108 and acts to support and stabilise the oscillating movement of jaw 105.

Referring to FIGS. 1 to 3, jaw 105 is suspended within crusher 100 via shaft 107 that extends through a cylindrical bore (defined by an inward facing surface 211) provided at jaw upper end 110. Shaft 107 comprises a generally cylindrical shape configuration having a pair of first and second ends 202 that projects axially outward from the cylindrical bore at each respective side 210 of movable jaw 105. Shaft 107 also comprises a first pair of mount regions 203 positioned at either axial side of an axially central section 303. Each mount region 203 is eccentric relative to a longitudinal axis 300 extending generally centrally through shaft 107. Mount regions 203 comprises a radially outward facing mount surface 204 being substantially parallel to axis 300, with each mount surface 204 being eccentric relative to axis 300. Shaft 107 further comprises a pair of second mount regions 209 positioned axially either side of first mount regions 203 with second mount regions 209 positioned axially closer to shaft ends 202. A radially outward facing surface 206 at each second mount region 209 is concentric and also aligned substantially parallel to axis 300. A diameter of shaft 107 at each first mount region 203 is greater than a diameter at each second mount region 209 due to the eccentric mass that is displaced radially off-set relative to axis 300. The diameter of shaft 107 decreases generally in the axially outward direction from each second mount region 209 towards shaft ends 202.

The present jaw mounting assembly further comprises a pair of jaw bearings 200 that are positioned radially intermediate jaw 105 and shaft 107. In particular, a radially outer region of each bearing 200 is positioned in contact against inner surface 211 that defines the cylindrical bore extending internally with jaw 105 between sides 210. A corresponding radially inner region of bearing 200 is positioned in contact against shaft surface 204. Additionally, a pair of frame bearings 201 are positioned radially intermediate a frame part 212 of crusher 100 and shaft 107 and are configured to mount shaft 107 generally at crusher 100. Accordingly, shaft 107 is capable of rotation about axis 300 relative to frame part 212 so as to induce a corresponding gyroscopic procession of jaw 105 that is thrown eccentrically about axis 300 via the eccentric mounting of bearings 200 at regions 203. Each frame bearing 201 is mounted at each respective second mount region 209 via an intermediate annular seat 205 having a generally tapered radial thickness to provide a wedge-like configuration when viewed in cross section (in a plane parallel to axis 300). According to further embodiments, jaw and frame bearings 200, 201 may be mounted either in direct or indirect contact with the outer facing surface 204, 206 (at each respective mount region 203, 209) with the assembly optionally further comprising intermediate mounting gaskets or seats of the type indicated generally by reference 205.

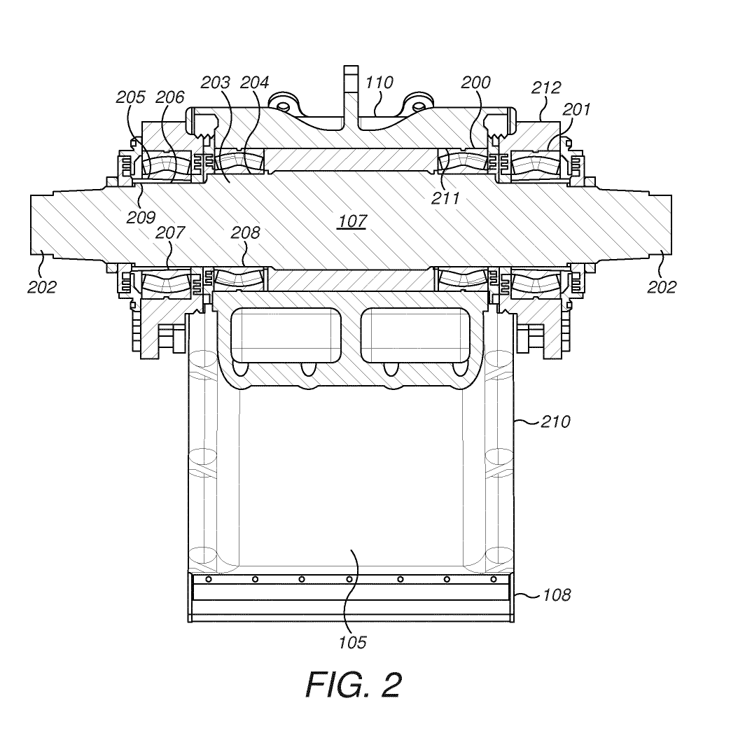

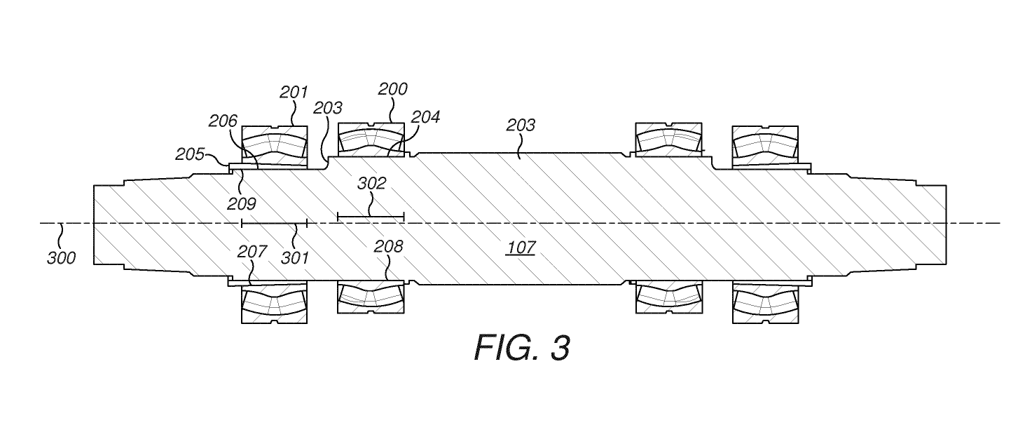

Jaw bearings 200 comprise a generally annular configuration in which an inner diameter is defined by a radially inward facing surface 208 positioned in direct contact with the mount region surface 204. Due to the eccentric mass at each region 203, a central axis 302 of jaw bearings 200 (and also mount region surface 204) is displaced radially relative to axis 300 so as to be off-set by a predetermined distance. Additionally, frame bearings 201 also comprise a generally annular configuration having a radially inward facing surfaces 207 that are positioned in contact against the outer facing surfaces 206 at second mount regions 209. As illustrated in FIGS. 2 and 3, according to the specific implementation, the inner diameter of jaw bearings 200 (as defined by annular inner surface 208) is greater than a corresponding inner diameter of frame bearings 201 (as defined by inner surface 207).

Accordingly, as mount regions 209 are concentric relative to axis 300, a central axis 301 defined by frame bearing inner surfaces 207 (and surface 206) is concentric relative to axis 300. As such, jaw bearing axis 302 is eccentric relative to frame bearing axis 301. To achieve a desired throw or stroke, axis 302 is off-set from axis 301 by a distance in the range 20 mm to 35 mm. Such a configuration is advantageous to appreciably increase the capacity of the jaw crusher 100 by increasing the throw of crushing plate 114 during crushing. Mounting jaw 105 via the arrangement of FIGS. 1 to 3 in which jaw bearings 200 are eccentrically mounted relative to frame bearings 201 by 20 mm to 35 mm optimises the travel of jaw 105 and in particular the change in separation distance (in a horizontal plane) between plates 113 and 114 over the entire length of the jaws 104, 105 between the upper and lower ends 110, 108. As will be appreciated, the nip angle and the angle of inclination of toggle plate 116 may also be adjusted within the confines of the subject invention to further achieve the desired capacity and reduction.

Referring to FIG. 5, the subject invention is optimised to achieve the desired capacity and reduction with respect to different crusher sizes. The crusher size may be represented with reference to the size of the intake at the upper region of crushing zone 103 including in particular a separation distance 500 between the side liners 106 and/or an inside surface 502 of the opposed sidewalls 400. The intake size may be further defined with reference to the separation distance 501 between upper edges 503, 504 of the jaw plates 114, 113 mounted at the respective movable jaw 105 and fixed jaw 104. In particular, the inventors have identified that to achieve a significantly high capacity whilst maintaining desired magnitudes of reduction via the increased eccentricity of axis 302 relative to axis 301, consideration must be given to other components of the crusher and control parameters. Without such further considerations a crusher according to the subject invention with the relative eccentricity of axis 302 relative to axis 301 would be subject to exaggerated and damaging dynamic forces. In particular, to utilise a greater throw of jaw 105 to obtain higher capacity, motor 402 is configured to be generally larger (relative to conventional crusher arrangements for a given intake geometry/size) so as to accommodate the greater power draw for the crushing force achieved. The enhance magnitude of power transfer from motor 402 to flywheels 101 may further require high performing v-belts 401 and selecting the desired gearing between motor 402 and flywheel 101 (including internal gearing configurations of motor 402).

Utilising an eccentricity of jaw bearings 200 relative to frame bearings 201 requires operating the crusher at a lower speed in order to achieve the optimised capacity with regard to a balance between the compressive motion between plates 114, 113 and the material falling down through the crushing zone 103 due to gravity. The crusher speed may be defined as the angular velocity with which jaw 105 rotates about axis 300. The inventors have identified that to optimise crushing (with regard to capacity and reduction) involves consideration of the crusher intake size, angular velocity of movable jaw 105 and power of the motor 402. For example, an eccentricity of axis 302 relative to axis 301 at the upper limit towards 35 mm would necessitate a very low angular velocity of movable jaw 105 to avoid exaggerated dynamic forces. This in turn would negatively affect the reduction requiring additional intermediate crushing units being installed within the production line. Accordingly, it is desirable to maximise capacity whilst achieving the desired reduction so as to minimise the number of in-series crushers as will be appreciated. The present range of eccentricity of the jaw bearings (200) between 20 to 35 mm represents a balance within the practical limits of hardware and operation parameters.

Optimisation of crushers (according to the subject invention) of different sizes may be illustrated by way of example with reference to the eccentricity, intake size, motor power and speed of crusher operation for a different ranges of eccentricities (of axis 302 relative to axis 301) as detailed in table 1.

| | Eccentric¹ | Intake Size | | Power⁴ | Speed⁵ |
|---|---|---|---|---|---|
| | (mm) | Separation²(mm) | Width³(mm) | (kW) | (RPM) |
| 1 | 20-26 | 600-800 | 800-1000 | 110-180 | 200-260 |
| 2 | 20-28 | 800-1000 | 1000-1200 | 160-250 | 170-220 |
| 3 | 22-30 | 1000-1200 | 1200-1400 | 200-350 | 160-200 |
| 4 | 22-32 | 1200-1400 | 1400-1600 | 300-500 | 150-200 |
| 5 | 22-35 | 1200-1600 | 1200-2200 | 350-800 | 140-190 |

Table 1. Example crusher configurations: ¹‘Eccentric’ separation distance between axis 302 and axis 301; ²‘Separation’ 501; ³‘Width’ 501; ⁴‘Power’ output power of motor 402; and ⁵‘Speed’ angular velocity of movable jaw 105 about axis 300.

The above crusher sizes may be typically selected to suit types of rock (and the energy required to break them) and the size of the rock pieces introduced through the intake region. As will be appreciated, the length of the crushing plates 114, 113 will also affect the power draw and the power ranges detailed in table 1 relate to crushing jaws may comprise a length perpendicular to width 500 that is comparable to values found in the art (for respective intake sizes).

Accordingly, the subject invention is advantageous to achieve enhanced capacity whilst maintaining desired reduction levels within acceptable power draw ranges and overall crusher size (with regard to total crusher weight). The subject invention is further advantageous to minimise noise transmission from crusher 100 and surrounding structures due to a capability to operate the crusher 100 at a relatively lower speed compared to conventional crushers.

1. A crushing jaw mounting assembly for a jaw crusher comprising:
a rotatable shaft arranged to mount a first crushing jaw and by rotation cause the jaw to oscillate relative to a second jaw of a crusher, the shaft having at least one jaw bearing mount region that is eccentric relative to a central longitudinal axis of the shaft;
at least one jaw bearing mounted in contact around the mount region of the shaft, the jaw bearing being configured to provide an intermediate mount of the first jaw at the shaft;
at least one frame bearing mounted in contact around the shaft axially to one side of the jaw bearing to rotatably mount the shaft at a frame of the jaw crusher; and
a central axis of the eccentrically mounted jaw bearing is off-set from a central axis of the frame bearing by a distance in the range 20 mm to 35 mm.

2. The assembly as claimed in claim 1, wherein the distance is 20 mm to 28 mm.

3. The assembly as claimed in claim 1, wherein the distance is 22 mm to 32 mm.

4. The assembly as claimed in claim 1, wherein the distance is 20 mm to 26 mm.

5. The assembly as claimed in claim 1, wherein the distance is 24 mm to 35 mm.

6. The assembly as claimed in claim 1, wherein the central axis of the jaw bearing is eccentrically mounted relative to a central axis of the shaft.

7. The assembly as claimed in claim 1, wherein an inner diameter of the jaw bearing is greater than an inner diameter of the frame bearing.

8. The assembly as claimed in claim 1, further comprising at least one annular seat positioned radially intermediate the shaft and each of the jaw and/or frame bearings.

9. A jaw crusher comprising:
a substantially stationary jaw; and
a movable jaw movably mounted relative to the stationary jaw via the mounting assembly as claimed claim 1.

10. The jaw crusher as claimed in claim 9, wherein a separation distance between upper most edges of the first and second jaws is in a range of 600 to 1000 mm, a width of the first and second jaws in a direction perpendicular to the separation distance is in a range of 800 to 1200 mm, and the jaw bearing off-set distance is in a range of 20 to 28 mm.

11. The jaw crusher as claimed in claim 9, wherein a separation distance between upper most edges of the first and second jaws is in a range of 800 to 1200 mm, a width of the first and second jaws in a direction perpendicular to the separation distance is in a range 1000 to 1400 mm, and the jaw bearing off-set distance is in a range of 20 to 30 mm.

12. The jaw crusher as claimed in claim 9, wherein a separation distance between upper most edges of the first and second jaws is in a range of 1200 to 1600 mm, a width of the first and second jaws in a direction perpendicular to the separation distance is in a range of 1400 to 2200 mm, and the jaw bearing off-set distance is in a range of 22 to 35 mm.

13. The crusher as claimed in claim 10, further comprising a motor arranged to actuate the oscillation of the movable jaw, wherein the motor has an output power in the range of 110 to 350 kW.

14. The crusher as claimed in claim 11, further comprising a motor arranged to actuate the oscillation of the movable jaw, wherein the motor has an output power in the range of 160 to 800 kW.

15. A method of operating a jaw crusher comprising:
mounting a rotatable shaft within a frame of a jaw crusher via at least one frame bearing, the shaft having at least one jaw bearing mount region that is eccentric relative to a central longitudinal axis of the shaft;
mounting a first crushing jaw at the mount region via at least one jaw bearing; and
oscillating the first jaw by rotation of the shaft, wherein a central axis of the eccentrically mounted jaw bearing is off-set from a central axis of the frame bearing by a distance in a range of 20 to 35 mm.
